(19) United States
(12) Patent Application Publication
(10) Pub. No.: US 2025/0291128 A1
(43) Pub. Date: Sep. 18, 2025

(54) BUNDLE STRUCTURE, OPTICAL CONNECTION STRUCTURE OF BUNDLE STRUCTURE AND MULTICORE FIBER, AND METHOD FOR OPTICALLY CONNECTING BUNDLE STRUCTURE TO MULTICORE FIBER

(71) Applicant: FURUKAWA ELECTRIC CO., LTD., Tokyo (JP)

(72) Inventors: Tsubasa Sasaki, Tokyo (JP); Ryuichi Sugizaki, Tokyo (JP); Masanori Takahashi, Tokyo (JP)

(21) Appl. No.: 19/073,397

(22) Filed: Mar. 7, 2025

(30) Foreign Application Priority Data
Mar. 12, 2024 (JP) 2024-38256

(51) Int. Cl. G02B 6/40; G02B 6/255; G02B 6/38

(52) U.S. Cl. CPC G02B 6/40; G02B 6/255; G02B 6/3885

(57) ABSTRACT

A bundle structure includes two optical fibers, a capillary, and so on. Each of the optical fibers is a single-core optical fiber having a core and a cladding covering the core. An outer shape of a cross section taken perpendicularly to an axial direction of each of the optical fibers is not circular, and a straight-line portion is formed at a part of an outer periphery portion. Also, the optical fibers are disposed so that the respective straight-line portions thereof face each other. That is, the optical fibers are in line contact with each other on the cross section. Each of the optical fibers is inserted into a cavity of the capillary.

### TECHNICAL FIELD

The present invention relates to a bundle structure including a plurality of optical fibers, an optical connection structure of the bundle structure and a multicore fiber, and a method for optically connecting the bundle structure to the multicore fiber.

### BACKGROUND

Due to rapidly increasing traffic in optical communications in recent years, transmission capacity of the currently used single-core optical fibers is approaching its limit. As a way of further expanding communication capacity, a multicore fiber in which a plurality of cores are formed in one fiber has been proposed.

If the multicore fiber is used as a transmission path, each core of the multicore fiber is to be connected to another optical fiber or an optical element etc. to send and receive transmission signals. That is, fan-in/fan-out for connecting the multicore fiber to a plurality of single-core fibers is to be used.

As a way to connect such a multicore fiber and single-core fibers, Japanese Unexamined Patent Application Publication No. 2017-167299 (JP-A-2017-167299), for example, has disclosed a method in which a plurality of single-core fibers are inserted into a capillary to be in a predetermined arrangement and the single-core fibers are fixed to the capillary so as to be connected to a multicore fiber.

FIG. 10A is a cross-sectional view showing a state in which a conventional multicore fiber 100 is inserted into a glass-made capillary 105. The multicore fiber 100 includes a plurality of cores 101 disposed inside a substantially circular cladding 103. For example, in the illustrated example, the two cores 101 are disposed inside the cladding 103.

To be optically connected to such the multicore fiber 100, a bundle structure 110 in which optical fibers 107 with small diameters are inserted into a glass-made capillary 113, as shown in FIG. 10B, has been conventionally used. Each of the optical fibers 107 is a single-core optical fiber in which a core 109 is disposed at a center of a cladding 111, and, in the illustrated example, two of the optical fibers 107 are inserted into the capillary 113.

An outer diameter of each optical fiber 107 is identical to a pitch between the cores 101 of the multicore fiber 100. For example, if the pitch of the cores 101 of the multicore fiber 100 is 50 μm, the optical fiber 107 having the outer diameter of 50 μm is to be used.

In such the state, the capillary 105 and the capillary 113 are aligned in X-Y directions and a rotational direction to align the cores 101 with the cores 109, and are bonded with adhesive. In this way, a bundle structure including optical fibers 107 can be optically connected to the multicore fiber 100.

On the other hand, to improve fan-in/fan-out reliability and to enhance high-power resistance, fusion splicing is more preferable than adhesive splicing. However, a conventional fan-in/fan-out structure has large vacant space inside the capillary 113 since the small-diameter optical fibers 107 are inserted into the capillary 113. In addition, when fusing such the bundle structure 110 to the multicore fiber 100, because the optical fibers 107 are only in point contact with each other, the optical fibers 107 soften by heat at the time of fusion and deform, filling the vacant space between the optical fibers 107 and the capillary 113, which may cause position shifting of the cores 109.

### SUMMARY OF THE DISCLOSURE

The present invention was made in view of such problems. It is an object of the present invention to provide a bundle structure and the like that can suppress position shifting of optical fibers when being fusion spliced to a multicore fiber.

To achieve the above object, a first aspect of the present invention is a bundle structure including a plurality of optical fibers and a capillary into which the plurality of optical fibers are inserted. Each of the optical fibers includes a core and a cladding that covers the core. Each of the optical fibers has a straight-line portion formed on a part of an outer periphery portion on a cross section taken perpendicularly to an axial direction thereof, and the optical fibers are disposed such that the straight-line portion face each other.

A softening temperature of the capillary is preferably lower than a softening temperature of the optical fibers.

A distance between the core and the straight-line portion is preferably 10 μm or more.

The straight-line portion may be formed in at least two directions.

On a cross section taken perpendicularly to an axial direction of the capillary, a ratio of a cross-sectional area of a vacant space of a cavity into which the optical fibers are inserted to a total cross-sectional area of the optical fibers is preferably 0.15 or less.

Each of the optical fibers may include an arc portion on the outer periphery portion except at the straight-line portion, and the core may be disposed at a position deviated from a center of a virtual circle formed by extending the arc portion.

The bundle structure may include the seven optical fibers. On the cross section taken perpendicularly to the axial direction of the capillary, the optical fiber that is to be disposed at a center may have the six straight-line portions on an outer periphery surface, and the six optical fibers each having the three straight-line portions may be disposed around the optical fiber at the center with the respective straight-line portions thereof being disposed to face each other.

The bundle structure may include the eight optical fibers. On the cross section taken perpendicularly to the axial direction of the capillary, each of the four optical fibers, which are disposed two by two in horizontal and vertical directions in the middle, may have the three straight-line portions, and the four optical fibers may be disposed so that the respective straight-portions thereof face each other. On both sides of the optical fibers in the middle, the end-side optical fibers each having the two straight-line portions on the outer periphery surface are disposed interposing the optical fibers in the middle such that the straight-line portions of the end-side optical fibers face the straight-line portions of the optical fibers in the middle, respectively, as well as the respective straight-line portions of the adjacent end-side optical fibers face each other.

According to the first aspect of the present invention, the straight-line portion is formed on the outer periphery surface on the cross section of the optical fiber, and the plurality of optical fibers are disposed such that the straight-portions face each other. Thus, compared to the conventional case in which optical fibers are in point contact, position shifting of the optical fibers at the time of fusion can be suppressed. Also, it is possible to make the vacant space other than the optical fibers inside the cavity of the capillary smaller, and this can relatively increase heat capacity of the optical fibers. This can suppress softening of the optical fibers by discharge heat at the time of fusion and suppress position shifting of the optical fibers.

In particular, making the softening temperature of the capillary lower than the softening temperature of the optical fibers can suppress softening of the optical fibers, and thus the capillary can be softened preferentially. Thus, softening of the capillary can fill the vacant space between the optical fibers and the capillary, and this can suppress position shifting of the optical fibers.

Also, if the distance between the core of the optical fiber and the straight-line portion is 10 μm or more, optical loss can be suppressed.

Also, by forming the straight-line portion in at least two directions, the optical fibers can be disposed facing each other in at least two directions or more.

Also, on the cross section taken perpendicularly to the axial direction of the capillary, the ratio of the cross-sectional area of the vacant space of the cavity into which the optical fibers are inserted to the total cross-sectional area of the plurality of optical fibers is preferably 0.15 or less, and this can efficiently suppress position shifting of the optical fibers.

Also, if each of the optical fibers includes the arc portion on the outer periphery portion except at the straight-line portion with the core disposed at a position deviated from the center of the virtual circle formed by extending the arc portion, an overall outline shape can be made almost like a circle when the straight-line portions are disposed facing each other. This can minimize the vacant space other than the optical fibers when being inserted into the cavity of the capillary. Thus, position shifting of the optical fibers can be efficiently suppressed.

As such the bundle structure, for example, the one optical fiber disposed at the center has the six straight-line portions on the outer periphery surface thereof, and the six optical fibers each having the three straight-line portions are disposed around the optical fiber at the center. In this way, the bundle structure can be optically connected to a seven-core multicore fiber in which the distance between the adjacent cores is constant.

Also, for example, if each of the four optical fibers disposed two by two in the middle has the three straight-line portions on the outer periphery surface thereof, the two each of the optical fibers are disposed in vertical and horizontal directions so that the two straight-portions thereof face each other, and, furthermore, the two optical fibers each having two straight-line portions are disposed on either side so as to interpose the four optical fibers in the middle, the bundle structure can be optically connected to an eight-core lattice-arrangement multicore fiber.

A second aspect of the present invention is an optical connection structure between the bundle structure according to the first aspect of the present invention and a multicore fiber. In the optical connection structure, cores of the multicore fiber are aligned with the cores of the plurality of optical fibers to be fusion spliced to each other.

According to the second aspect of the present invention, the optical connection structure in which the plurality of optical fibers are fusion spliced to the multicore fiber with precision can be obtained.

A third aspect of the present invention is a method for optically connecting the bundle structure according to the first aspect of the present invention to a multicore fiber. The method includes temporarily bonding the capillary and the optical fibers by fusion, disposing the optical fibers and the multicore fiber to face each other to be aligned, and fusion splicing the optical fibers to the multicore fiber.

According to the third aspect of the present invention, the plurality of optical fibers and the multicore fiber can be fusion spliced with precision.

The present invention can provide a bundle structure and the like that can suppress position shifting of optical fibers when being fusion spliced to a multicore fiber.

### BRIEF DESCRIPTION OF DRAWINGS

FIG. 1A is a cross-sectional view showing a bundle structure 1.

FIG. 1B is a view showing a cross-sectional area of optical fibers 3.

FIG. 1C is a view showing a cross-sectional area of a vacant space in a cavity 11 of a capillary 9.

FIG. 2A is a view showing a method for constructing the optical fiber 3 in the bundle structure 1.

FIG. 2B is a view showing the method for constructing the optical fiber 3 in the bundle structure 1.

FIG. 2C is a view showing the method for constructing the optical fiber 3 in the bundle structure 1.

FIG. 3A is a cross-sectional view showing a multicore fiber 20.

FIG. 3B is a cross-sectional view showing a bundle structure 1a.

FIG. 4A is a view showing a method for constructing the optical fiber 3 in the bundle structure 1a.

FIG. 4B is a view showing the method for constructing the optical fiber 3 in the bundle structure 1a.

FIG. 4C is a view showing the method for constructing the optical fibers 3 in the bundle structure 1a.

FIG. 5A is a view showing a method for constructing the optical fiber 3 in a bundle structure 1b.

FIG. 5B is a view showing the method for constructing the optical fiber 3 in the bundle structure 1b.

FIG. 5C is a view showing the method for constructing the optical fibers 3 in the bundle structure 1b.

FIG. 5D is a cross-sectional view of the bundle structure 1b.

FIG. 6A is a view showing a method for constructing the optical fiber 3 in a bundle structure 1c.

FIG. 6B is a view showing the method for constructing the optical fiber 3 in the bundle structure 1c.

FIG. 6C is a view showing the method for constructing the optical fibers 3 in the bundle structure 1c.

FIG. 6D is a cross-sectional view of the bundle structure 1c.

FIG. 7A is a cross-sectional view of a bundle structure 1d.

FIG. 7B is a view showing an optical fiber 3a before processing.

FIG. 8A is a cross-sectional view of a bundle structure 1e.

FIG. 8B is a view showing the optical fiber 3 before processing.

FIG. 8C is a view showing the optical fiber 3a before processing.

FIG. 9A is cross-sectional view of a bundle structure 1f.

FIG. 9B is a view showing the optical fiber 3 before processing.

FIG. 9C is a view showing the optical fiber 3 before processing.

FIG. 10A is a cross-sectional view of a conventional multicore fiber 100.

FIG. 10B is a cross-sectional view of a conventional bundle structure 110.

### DETAILED DESCRIPTION

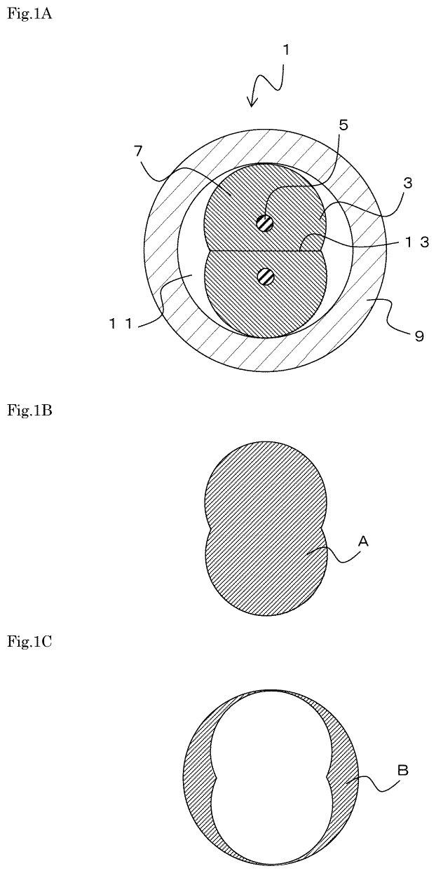

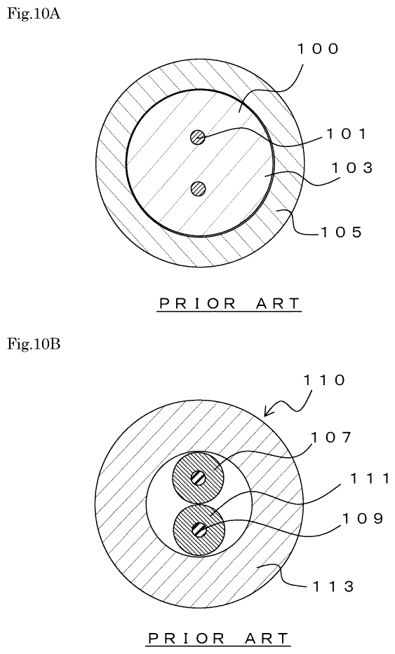

Hereinafter, a bundle structure according to an embodiment of the present invention will be described. FIG. 1A is a view showing a bundle structure 1 including a plurality of optical fibers 3, and is a cross-sectional view taken perpendicularly to an axial direction of a capillary 9. The descriptions hereafter will be made on the premise that the bundle structure 1 is to be connected to the above-mentioned multicore fiber 100 (FIG. 10A).

The bundle structure 1 includes the two optical fibers 3, the capillary 9, and so on. The optical fibers 3 are single-core optical fibers each having a core 5 and a cladding 7 covering the core 5. Instead of a circular outer shape, each of the optical fibers 3 has, on a cross section taken perpendicularly to an axial direction, a straight-line portion 13 (a flat surface of the optical fiber 3) formed at a part of an outer periphery portion thereof. Also, the respective optical fibers 3 are disposed such that the straight-line portions 13 thereof face each other. That is, the optical fibers 3 are in line contact with each other on the cross section.

Each of the optical fibers 3 is inserted into a cavity 11 of the capillary 9. Although the optical fibers 3 and the capillary 9 are all made of glass, it is possible to make a softening temperature of the capillary 9 lower than a softening temperature of the optical fiber 3 by using different materials. For example, borosilicate glass may be used for the capillary 9, and silica glass may be used for the optical fibers 3.

Here, on the cross section taken perpendicularly to the axial direction of the capillary 9, a ratio of a cross-sectional area of a vacant space of a cavity into which the optical fibers 3 are inserted (B in FIG. 1C) to a total cross-sectional area of the optical fibers 3 (A in FIG. 1B) is preferably 0.15 or less. As shown in FIG. 10B, in the conventional bundle structure, the optical fibers 107 are in point contact with each other on the cross section with a large cross-sectional area of the vacant space, in which the ratio of the total cross-sectional area of the optical fibers 107 to the total cross-sectional area of the vacant space is approximately 1:1. However, as shown in FIG. 1A, forming the straight-line portions 13, which are to be disposed facing each other, can make the total cross-sectional area of the optical fibers 3 seven times or more the total cross-sectional area of the vacant space.

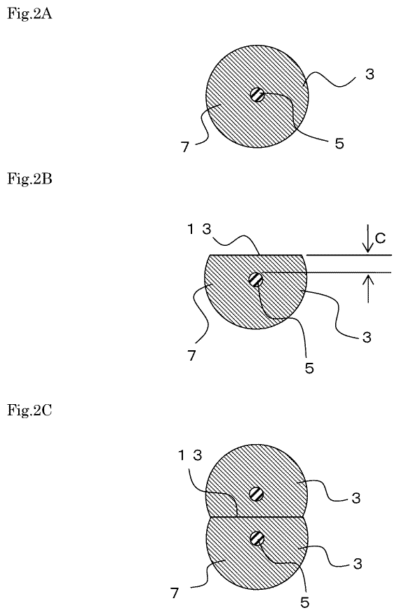

Next, a method for making the bundle structure 1 will be described. First, as shown in FIG. 2A, the single-core optical fiber 3 with a circular outer shape is prepared. For example, for a multicore fiber with a core pitch of 50 μm, the optical fiber 3 with a diameter of 125 μm can be used.

Next, as shown in FIG. 2B, the straight-line portion 13 is formed at a part of an outer surface of the optical fiber 3 on the cross section. To form the straight-line portion 13 in this way, for example, a part of the optical fiber may be cut by laser, or a part of a side surface thereof may be removed by polishing, etching, or the like. Alternatively, instead of using the circular optical fiber, the cladding 7 may be processed from the beginning into a shape having the straight-line portion 13 and then a line may be drawn. As above, the method for forming the straight-line portion 13 is not specifically limited.

As shown in FIG. 2B, the shortest distance between the core 5 and the straight-line portion 13 (C in the drawing) is preferably 10 μm or more. If the core 5 is too close to an outer periphery surface of the cladding 7, optical loss due to light leakage may occur.

Next, as shown in FIG. 2C, a pair of the optical fibers 3 with the straight-line portions 13 being formed are disposed facing each other such that the straight-line portions 13 are in contact with each other, and are inserted into the capillary 9 to form the bundle structure 1. After inserting the optical fibers 3 into the cavity 11 of the capillary 9, the capillary 9 and the optical fibers 3 may be temporarily bonded by fusion (fixing the optical fibers 3 to the capillary 9 with smaller quantity of heat than in the main fusion).

Next, a method for optically connecting the bundle structure 1 to the multicore fiber 100 will be described. The bundle structure 1 after the temporary fusion as mentioned above, for example, is disposed facing the multicore fiber 100 inserted into the capillary 105 (see FIG. 10A), and positions of the cores 5 and the cores 101 in X-Y directions and a rotational direction are aligned. Then, the multicore fiber 100 and the bundle structure 1 are spliced by fusion so as to obtain a connection structure of the bundle structure 1 and the multicore fiber 100.

Here, when fusion splicing the multicore fiber 100 and the bundle structure 1, it is preferable that outer diameters of the capillary 9 and the capillary 105 are substantially identical. In this way, when an arc applies heat from outside, the multicore fiber 100 and the bundle structure 1 (the optical fibers 3) inside can be heated substantially evenly.

On the other hand, in the conventional bundle structure 110 (see FIG. 10B), the optical fibers 107 having small diameters (e.g., 50 μm×2) are inserted and thus an inner diameter of the cavity (e.g., 100 μm+α (e.g., α=0.3 μm to 1.0 μm)) is small. Thus, if an outer diameter of the capillary 113 is to be substantially identical to the outer diameter of the capillary 105 of the multicore fiber 100, a thickness of the capillary 113 is to be increased. As a result, at the time of fusion, the heat capacity of the capillary 113 becomes too large and the optical fibers 107 soften first before the entire capillary 113 softens, which may cause position shifting of the optical fibers 107.

In contrast, in the bundle structure 1, if the optical fiber 3 having a diameter of 125 mm, for example, is processed, an inner diameter of the cavity 11 can be 175 μm+α (e.g., α=0.3 μm to 1.0 μm) even with a core pitch of 50 μm. Thus, a thickness of the capillary 9 can be made relatively small and the heat capacity can be made smaller compared to the conventional case. As a result, the entire capillary 9 can soften before the optical fibers 3 softens, and the vacant space surrounding the optical fibers 3 can be filled up by the softening of the capillary 9 at an early stage of start of discharge. This can suppress position shifting of the optical fibers 3 and, then, the optical fibers 3 and the multicore fiber 100 can be fusion spliced. To obtain such effects, the outer diameter of the capillary 9 is preferably 0.3 mm or less, for example.

As above, according to the present embodiment, the bundle structure 1 is formed by disposing the optical fibers 3, with the straight-line portions 13 on the cross sections thereof, to face each other. Thus, compared to the conventional case in which the optical fibers are in point contact on the cross section, position shifting between the optical fibers 3 can be suppressed.

In particular, the total cross-sectional area of the optical fibers 3 can be increased, which increases the heat capacity of the optical fibers 3 with respect to the capillary 9 and thus the capillary 9 can be softened preferentially. For example, when optical fibers each having a diameter of 125 μm are processed and disposed facing each other so that the core pitch is 50 μm, compared to a case in which a fiber with a small diameter of 50 μm is used (FIG. 10B), the total cross-sectional area of the optical fibers is five times or more as well as the heat capacity can be five times or more. This can delay the start of softening of the optical fibers 3 at the early stage of start of discharge and suppress position shifting of the optical fibers 3.

Also, compared to the conventional case, it is possible to reduce the area of the vacant space other than the optical fibers 3 inside the capillary 9. For example, the cross-sectional area of the vacant space to the total cross-sectional area of the optical fibers 3 can be 0.15 or less. Thus, the vacant space surrounding the optical fibers 3 can be efficiently filled by softening of the capillary 9. This can suppress position shifting of the optical fibers 3.

Also, as mentioned above, the softening temperature of the capillary 9 is made lower than the softening temperature of the optical fibers 3. In this way, the capillary 9 can be more efficiently softened preferentially at the early stage, filling the vacant space, and then the optical fibers 3 can be fusion spliced to the multicore fiber 100.

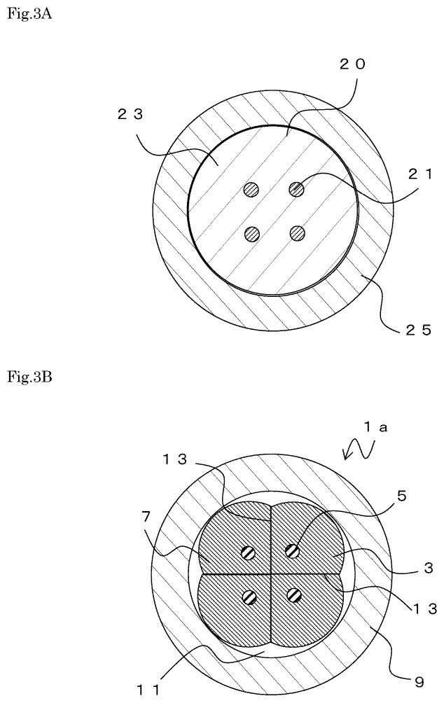

Although the bundle structure 1 to be connected to the double-core multicore fiber 100 has been described in the above embodiment, the number of cores of the bundle structure is not limited thereto. For example, FIG. 3A is a cross-sectional view of a state in which a four-core multicore fiber 20 is inserted into a capillary 25. In the descriptions hereinafter, configurations demonstrating the same effects as in the configurations shown in FIG. 1A to FIG. 2C will have the same notations and redundant explanations will be omitted.

The multicore fiber 20 also has a structure in which cores 21 are covered by a cladding 23, and the four cores 21 are disposed at equal intervals so as to be vertices of a square on a cross section. That is, distances between the adjacent cores 21 are equal and a core pitch is, for example, 40 μm.

FIG. 3B is a view showing a cross-sectional view of a bundle structure 1a that is to be connected to such the multicore fiber 20. In the present embodiment, the four optical fibers 3 are disposed such that the straight-line portions 13 thereof face each other. At this time, while the one optical fiber 3 has only the one straight-line portion 13 in the above-mentioned embodiment, the straight-line portions 13 are formed in two directions in the present embodiment. In more detail, the straight-line portions 13 are formed to be orthogonal to each other on the cross section.

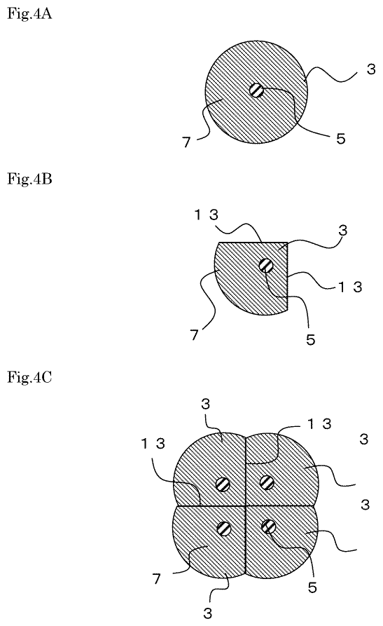

FIG. 4A to FIG. 4C show a process of making such the bundle structure 1a. First, as shown in FIG. 4A, the single-core optical fiber 3 having the core 5 at the center is prepared, and then, as shown in FIG. 4B, a part of the outer periphery portion is removed to form the straight-line portions 13 so as to be orthogonal to each other. The length of the straight-line portion 13 in each direction is the same.

The four optical fibers 3 with the straight-line portions 13 being formed in this way are produced and disposed such that the straight-line portions 13 thereof face each other as shown in FIG. 4C. The optical fibers 3 are then inserted into the capillary 9 to form the bundle structure 1a. Also in such the case, the optical fibers 3 and the capillary 9 may be temporarily bonded by fusion.

As above, the straight-line portion 13 may be formed not only in one direction but also in two or more directions on the cross section. The number of the optical fibers 3 and the forming positions of the straight-line portions 13 may be appropriately determined according to the number of cores of the multicore fiber to be connected.

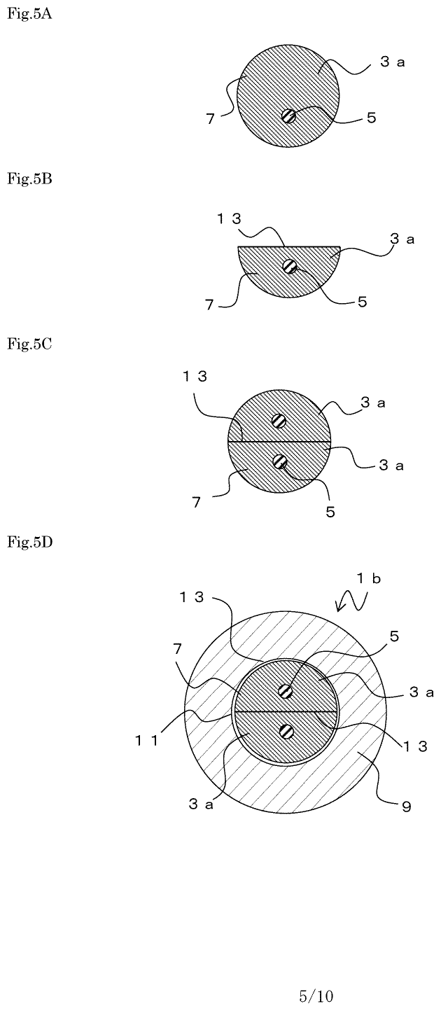

Also, although the optical fiber 3 used when forming the straight-line portions 13 is a single-core fiber having the core 5 located at the center, the present invention is not limited thereto. FIG. 5A is a cross-sectional view showing an optical fiber 3a. Although the single-core optical fiber 3a has a circular outer shape like the optical fiber 3, instead of being disposed at the center of the cladding 7, the core 5 is disposed at a position deviated from the center.

As shown in FIG. 5B, for such the optical fiber 3a, the cladding 7 on a side opposite to an eccentric direction of the core 5 is removed. For example, by removing a half of an outer diameter of the optical fiber 3a passing through the center of the cladding 7, the length of the straight-line portion 13 can be substantially identical to the outer diameter of the optical fiber 3a. At this time, to have a distance of 10 μm or more between the core 5 and the straight-line portion 13, the core 5 is to be eccentric for (10 μm+α radius of the core 5) or more from the center of the optical fiber 3a.

As shown in FIG. 5C, the optical fibers 3a obtained as above are disposed such that the straight-line portions 13 thereof face each other and are then inserted into the capillary 9 to form a bundle structure 1b shown in FIG. 5D. That is, the optical fiber 3a in the bundle structure 1b has an arc portion on the outer periphery portion thereof except at the straight-line portion 13, and the core 5 is disposed being eccentric from a center of a virtual circle formed by extending the arc portion (i.e., an outline shape of the cladding 7 in FIG. 5A).

By using such the optical fibers 3a, when the two optical fibers 3a are disposed facing each other, for example, the joined outline shape can be made almost like a circle. This can minimize the vacant space in the cavity 11 of the capillary 9. Here, in a case in which the two optical fibers 3a are disposed facing each other to have a diameter of 100 μm, it is impossible to insert the optical fibers 3a if the capillary 9 has an inner diameter of 100.2 μm or less, and, if the inner diameter of the capillary 9 is more than 101 μm, positions of the optical fibers in the capillary 9 may become unstable and connection loss at the time of connecting to the facing multicore fiber is likely to increase. Thus, the inner diameter of the cavity 11 is preferably around 100 μm+0.3 to 1.0 μm. When the inner diameter of the capillary 9 is D and the optical fibers 3a with the diameter of 100 μm is inserted, the ratio X of the total cross-sectional area of the optical fibers 3a to the cross-sectional area of the vacant space is calculated as follows: X=249.8 when D=100.2 μm, X=166.4 when D=100.3 μm, X=124.8 when D=100.4 μm, X=99.8 when D=100.5 μm, X=83.1when D=100.6 μm, X=71.2 when D=100.7 μm, X=62.3 when D=100.8 μm, X=55.3 when D=100.9 μm, X=49.8 when D=101.0 μm, X=45.2 when D=101.1 μm, and X=41.4 when D=101.2 μm. As above, by increasing the total cross-sectional area of the optical fibers 3a with respect to the cross-sectional area of the vacant space, position shifting of the optical fibers 3a can be suppressed.

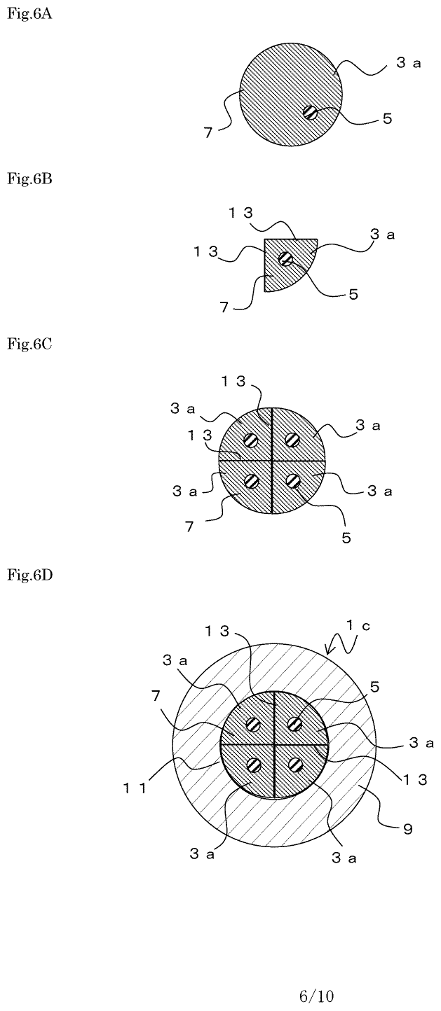

By using such the optical fibers 3a with the eccentric cores, a bundle structure with four cores can also be obtained. In such the case, as shown in FIG. 6A, for the single-core optical fiber 3a having the eccentric core 5, a part of the cladding 7 is removed in two directions that are orthogonal to each other as shown in FIG. 6B. In such the case, the straight-line portions 13 of approximately the same length are formed so as to be orthogonal to each other and at an angle of ±45° with respect to the eccentric direction of the core 5 (to the lower right direction in the drawing) when viewed from the center of the optical fiber 3a.

The optical fibers 3a obtained as above are disposed such that the straight-line portions 13 face each other as shown in FIG. 6C and are then inserted into the capillary 9 as shown in FIG. 6D to form a bundle structure 1c in which the cores 5 are disposed at equal intervals. Even in such the case, when the four optical fibers 3a are disposed to face each other, the outline shape can be made substantially circular. This can minimize the vacant space in the cavity 11 of the capillary 9. Thus, position shifting of the optical fibers 3a can be suppressed.

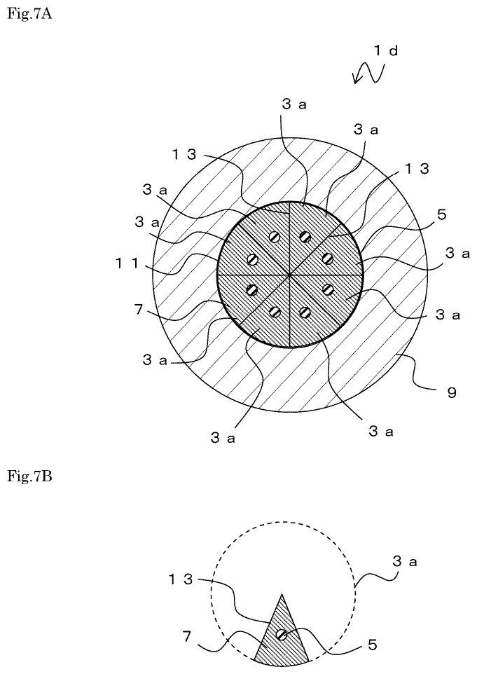

This can also be applied to a multicore fiber with more cores. FIG. 7A is a cross-sectional view showing a bundle structure 1d, and FIG. 7B is a view showing an outline shape of the optical fiber 3a before processing. As mentioned above, the core 5 is disposed at a position deviated from the center of the optical fiber 3a. The straight-line portions 13 (the straight-line portions 13 passing through the center of the original optical fiber 3a) are formed in two directions at a predetermined angle so as to interpose the core 5 of the optical fiber 3a. For example, by having an inner angle of 45° between the straight-line portions 13, the eight-core bundle structure 1d in which the cores 5 are disposed at equal intervals in a circumferential direction can be obtained. As above, the number of the optical fibers 3a can be set according to the number of cores of the multicore fiber to be connected.

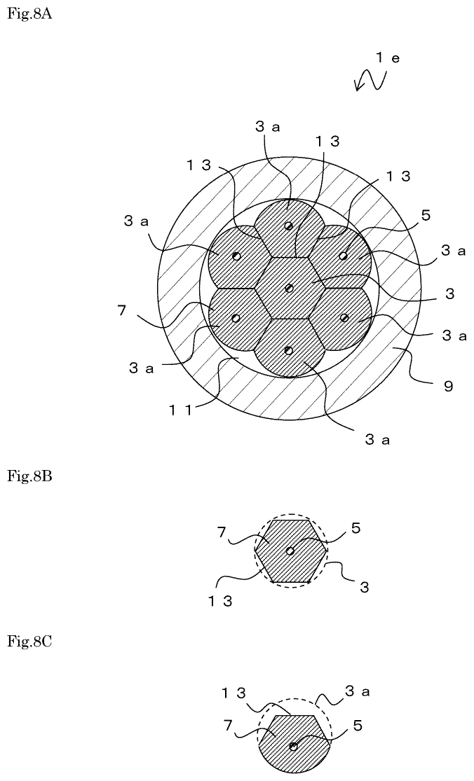

Also, the optical fibers 3 and 3a may be used together to form a multicore bundle structure. FIG. 8A is a view showing a bundle structure 1e, FIG. 8B is a view showing an outline shape of the optical fiber 3 before processing, and FIG. 8C is a view showing an outline shape of the optical fiber 3a before processing. The bundle structure 1e includes the total of seven optical fibers 3 and 3a: the one optical fiber 3 and the six optical fibers 3a.

The optical fiber 3 is disposed at a center of the bundle structure 1e on a cross section taken perpendicularly to the axial direction of the capillary 9. The optical fiber 3 disposed at the center is formed into a substantially regular hexagon having the six straight-line portions 13 on an outer periphery surface thereof. The six optical fibers 3a are disposed around the optical fiber 3 at the center. Each of the six optical fibers 3a has the three straight-line portions 13 at parts other than the arc portion. In more detail, the straight-line portions 13 are formed in three directions, with internal angles of 120°, on both sides of the central straight-line portion 13. The six straight-line portions 13 of the optical fiber 3 at the center and the three straight-line portions 13 of each of the surrounding optical fibers 3a all have the same length.

As above, the optical fibers 3 and 3a are disposed such that the central straight-line portions 13 of the surrounding optical fibers 3a face each of the straight-line portions 13 of the optical fiber 3 at the center, and the straight-line portions 13 of the adjacent optical fibers 3a face each other. In this way, the cores 5 can be disposed such that distances between the adjacent cores 5 are all the same, which enables an optical connection to the corresponding seven-core multicore fiber.

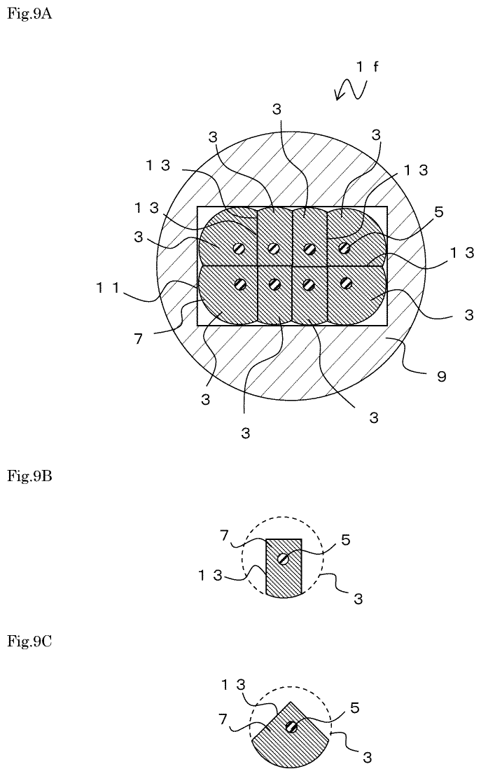

Also, the cavity 11 of the capillary may not be circular. FIG. 9A is a cross-sectional view showing a bundle structure 1f, and FIG. 9B and FIG. 9C are views showing outline shapes of the optical fibers before processing, respectively. The bundle structure 1f includes the eight optical fibers 3. Also, in the present embodiment, the cavity 11 of the capillary 9 is substantially rectangular, and the optical fibers 3 are inserted into the cavity 11.

On a cross section taken perpendicularly to the axial direction of the capillary 9, the optical fibers 3 are disposed in two tiers by four rows (sometimes referred to as a vertical direction and a horizontal direction). That is, on both sides of the four optical fibers 3 in two tiers by two rows, the optical fibers 3 in two tiers are disposed interposing the optical fibers 3 in the middle.

Each of the four optical fibers 3 disposed in the middle of the bundle structure 1f has the three straight-line portions 13 on the outer periphery surface so that the adjacent straight-line portions 13 are orthogonal to each other as shown in FIG. 9B. In more detail, the short straight-line portion 13 is formed on an opposite side of the arc portion with the core 5 therebetween, and the long straight-line portions 13 are formed on both sides of the short straight-line portion 13. Also, for the optical fibers 3 in the middle, the four optical fibers 3 are disposed in two tiers and two rows (in the vertical and horizontal directions) such that the two straight-line portions 13 of the optical fibers 3 face each other (the short straight-line portions 13 face each other in the vertical direction and the long straight-line portions 13 face each other in the horizontal direction).

The end-side optical fibers 3 are disposed on both sides, in the horizontal direction, of the optical fibers 3 in the two tiers in the middle, interposing the four optical fibers 3 in the middle of the bundle structure 1f from both sides in the horizontal direction. As shown in FIG. 9C, the end-side optical fiber 3 has on the outer periphery surface the two straight-line portions 13 of the same length that are orthogonal to each other. One of the straight-line portions 13 of each of the end-side optical fibers 3 is disposed to face the long straight-line portion 13 of the optical fiber 3 in the middle, and the straight-line portions 13 of the end-side optical fibers 3 that are adjacent in the vertical direction are disposed to face each other.

The distances between the cores 5 of the optical fibers 3 that are adjacent to each other in the vertical and horizontal directions are the same. In this way, the bundle structure can be optically connected to a multicore fiber having a lattice-like core arrangement of two tiers by four rows.

As above, by forming the straight-line portions 13 at suitable positions of the optical fibers 3 and 3a depending on the arrangement of the cores 5 and disposing the straight-line portions 13 to face each other, the bundle structure with the larger total cross-sectional area of the optical fibers and the smaller vacant space inside the cavity 11 of the capillary 9 than the conventional one can be obtained.

Although the embodiments of the present invention have been described referring to the attached drawings, the technical scope of the present invention is not limited to the embodiments described above. It is obvious that persons skilled in the art can think out various examples of changes or modifications within the scope of the technical idea disclosed in the claims, and it will be understood that they naturally belong to the technical scope of the present invention.

1. A bundle structure comprising:
a plurality of optical fibers, each of the plurality of optical fibers comprising a core and a cladding that covers the core; and
a capillary into which the plurality of optical fibers are inserted, wherein
each of the optical fibers has a straight-line portion formed on a part of an outer periphery portion on a cross section taken perpendicularly to an axial direction thereof; and
the optical fibers are disposed such that the straight-line portions face each other.

2. The bundle structure according to claim 1, wherein a softening temperature of the capillary is lower than a softening temperature of the optical fibers.

3. The bundle structure according to claim 1, wherein a distance between the core and the straight-line portion is 10 μm or more.

4. The bundle structure according to claim 1, wherein the straight-line portion is formed in at least two directions.

5. The bundle structure according to claim 1, wherein on a cross section taken perpendicularly to an axial direction of the capillary, a ratio of a cross-sectional area of a vacant space of a cavity into which the optical fibers are inserted to a total cross-sectional area of the optical fibers is 0.15 or less.

6. The bundle structure according to claim 1, wherein:
each of the optical fibers includes an arc portion on the outer periphery portion except at the straight-line portion; and
the core is disposed at a position deviated from a center of a virtual circle formed by extending the arc portion.

7. The bundle structure according to claim 1, the bundle structure comprising:
the seven optical fibers, wherein:
on the cross section taken perpendicularly to the axial direction of the capillary, the one optical fiber that is to be disposed at a center has the six straight-line portions on an outer periphery surface; and
the six optical fibers each having the three straight-line portions are disposed around the one of the optical fiber at the center with the respective straight-line portions thereof being disposed to face each other.

8. The bundle structure according to claim 1, the bundle structure comprising:
the eight optical fibers; wherein:
on the cross section taken perpendicularly to the axial direction of the capillary, the four optical fibers each having the three straight-line portions are disposed two by two in horizontal and vertical directions at a center, and the four optical fibers are disposed so that the respective straight-portions thereof face each other, respectively;
on both sides of the optical fibers in the middle, the end-side optical fibers each having the two straight-line portions on the outer periphery surface are disposed interposing the optical fibers in the middle such that the straight-line portions of the end-side optical fibers face the straight-line portions of the optical fibers in the middle, respectively, as well as the respective straight-line portions of the adjacent end-side optical fibers face each other.

9. An optical connection structure between the bundle structure according to claim 1 and a multicore fiber, wherein cores of the multicore fiber are aligned with the cores of the plurality of optical fibers to be fusion spliced to each other.

10. A method for optically connecting the bundle structure according to claim 1 to a multicore fiber, the method comprising:
temporarily bonding the capillary and the optical fiber by fusion;
disposing the optical fibers and the multicore fiber to face each other to be aligned; and
fusion splicing the optical fibers to the multicore fiber.
